(19) United States
(12) Patent Application Publication
(10) Pub. No.: US 2022/0185251 A1
(43) Pub. Date: Jun. 16, 2022

(54) ELECTROPNEUMATIC BRAKE SYSTEM FOR A UTILITY VEHICLE

(71) Applicant: ZF CV Systems Hannover GmbH, Hannover (DE)

(72) Inventors: Detlef Schmidt, Gehrden (DE); Julian Van Thiel, Grossburgwedel (DE)

(21) Appl. No.: 17/435,422

(22) PCT Filed: Mar. 4, 2020
(86) PCT No.: PCT/EP2020/055663

§ 371 Date: Sep. 1, 2021

(30) Foreign Application Priority Data
Mar. 12, 2019 (DE) 10 2019 106 243.8

(51) Int. Cl. B60T 8/94; B60T 8/32; B60T 13/68

(52) U.S. Cl. CPC B60T 8/94; B60T 8/329; B60T 13/683; B60T 13/385; B60T 2270/10; B60T 2270/402; B60T 2270/413; B60T 2240/00

(57) ABSTRACT

An electropneumatic brake system for a utility vehicle includes a front first brake cylinder and a front second brake cylinder on a front axle, the front first brake cylinder and the front second brake cylinder being configured to brake respective first and second front vehicle wheels. The system also includes a rear first brake cylinder and a rear second brake cylinder on a rear axle, the rear first brake cylinder and the rear second brake cylinder being configured to brake respective first and second rear vehicle wheels. The system additionally includes a central brake control device configured to output brake control signals for pneumatic pressurization of the front first and second brake cylinders and the rear first and second brake cylinders, and further includes two front wheel revolution rate sensors and two rear wheel revolution rate sensors configured to sense respective wheel revolution rates.

### CROSS REFERENCE TO RELATED APPLICATIONS

This application is a U.S. National Phase application under 35 U.S.C. § 371 of International Application No. PCT/EP2020/055663, filed on Mar. 4, 2020, and claims benefit to German Patent Application No. DE 10 2019 106 243.8, filed on Mar. 12, 2019. The International Application was published in German on Sep. 17, 2020 as WO 2020/182569 under PCT Article 21(2).

### FIELD

The present disclosure relates to an electropneumatic brake system for a utility vehicle.

### BACKGROUND

Service brake systems, in particular electronic brake systems (EBS), generally have a central electric brake control device, which can modulate braking processes on the front and rear wheel brakes by outputting electrical service brake signals. In this case, in part, the use of a second brake control device or an auxiliary control device is provided, which can maintain an auxiliary braking mode or at least a rudimentary braking mode or service braking mode in the event of failure of the central brake control device, which is also referred to as fail operation braking system (FOBS).

In regular braking mode, the central brake control device can generally perform brake slip control on the individual wheel brakes. In a fail operation braking mode, however, such brake slip controls are generally no longer possible.

EP 0 133 287 B1 describes a hydraulic automatic brake system in which a wheel revolution rate sensor outputs a pulse width modulated sensor signal. Here, the front left wheel revolution rate sensor and the front right wheel revolution rate sensor, as well as the rear wheel revolution rate sensors, are connected to different control units.

The three control units are connected to each other, especially in the event of a fault.

However, it turns out that these are generally very specific solutions and in particular are not applicable to electropneumatic brake systems used in utility vehicles.

### SUMMARY

In an embodiment, the present disclosure provides an electropneumatic brake system for a utility vehicle. The electropneumatic brake system includes a front first brake cylinder and a front second brake cylinder on a front axle, the front first brake cylinder and the front second brake cylinder being configured to brake respective first and second front vehicle wheels. The electropneumatic brake system also includes a rear first brake cylinder and a rear second brake cylinder on a rear axle, the rear first brake cylinder and the rear second brake cylinder being configured to brake respective first and second rear vehicle wheels. The electropneumatic brake system additionally includes a central brake control device configured to output brake control signals for pneumatic pressurization of the front first and second brake cylinders and the rear first and second brake cylinders. The electropneumatic brake system further includes two front wheel revolution rate sensors and two rear wheel revolution rate sensors configured to sense respective wheel revolution rates of the first and second front vehicle wheels and the first and second rear vehicle wheels and further configured to output respective wheel revolution rate signals. Furthermore, the electropneumatic brake system includes a second brake control device configured to actuate, in an at least partially electric auxiliary braking mode, the front first and second brake cylinders and the rear first and second brake cylinders in event of failure of the central brake control device. The two front wheel revolution rate sensors and the two rear wheel revolution rate sensors are divided into a first wheel revolution rate sensor group and a second wheel revolution rate sensor group. The first wheel revolution rate sensor group is configured to output respective wheel revolution rate sensor signals to the second brake control device, which is configured to relay the respective wheel revolution rate sensor signals to the central brake control device. The second wheel revolution rate sensor group is configured to output its wheel revolution rate sensor signals to the central brake control device. The central brake control device is designed to electrically actuate a slip controller of the vehicle wheels. The second brake control device is designed to actuate an auxiliary brake slip controller of the brake cylinders with the respective wheel revolution rate sensor signals of the first wheel revolution rate sensor group in the event of the failure of the central brake control device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an electropneumatic block diagram of a pneumatic brake system of a utility vehicle according to a first embodiment with crosswise subdivision of the wheel revolution rate sensors;

FIG. 2 shows an electropneumatic block diagram of a pneumatic brake system according to a further embodiment, in which compared to FIG. 1 the control of the electronic parking brake is combined in the further control device;

FIG. 3 shows the electropneumatic block diagram of a pneumatic brake system according to a further embodiment with asymmetric subdivision of the wheel revolution rate sensors; and

FIG. 4 shows an electropneumatic block diagram of a brake system according to a further embodiment with axle-wise subdivision of the wheel revolution rate sensors.

### DETAILED DESCRIPTION

The present disclosure provides an electropneumatic brake system for utility vehicles and a method for its operation or control, which allow a safe fail operation mode.

This disclosure provides an electropneumatic brake system and a method for controlling it. Furthermore, a vehicle with the electropneumatic brake system is provided, which in particular is provided for carrying out the method.

Thus, not only is a fail operation mode or an auxiliary braking mode provided for controlling the wheel brakes by the second brake control device in the event of electrical failure of the central brake control device, but in addition an auxiliary brake slip mode is provided by means of the second brake control device. For this purpose, the four wheel brake number sensors of the two wheels of the front axle and the two wheels of the rear axle are divided into two wheel revolution rate sensor groups, each of which is read by the central brake control device or the second brake control device. In particular, direct signal lines between the wheel revolution rate sensors and the respective brake control device are provided for this purpose, which—in the usual way—ensure high signal transmission reliability.

Due to the direct signal lines, redundant forwarding of a wheel revolution rate sensor signal from a wheel revolution rate sensor to both control devices is generally not possible without the additional hardware complexity, for example branching cables (Y-cables). In order to avoid such branching cables or the use of dual wheel revolution rate sensors on the individual vehicle wheels, the wheel revolution rate sensors are divided into the two wheel revolution rate sensor groups. Thus, no additional hardware complexity is incurred due to special branching cables or dual wheel revolution rate sensors.

The second brake control device not only allows a redundant brake control mode (auxiliary braking mode) by controlling the wheel brakes in the event of electrical failure of the central brake control device, but in addition preferably a redundant brake slip control mode by estimating the wheel revolution rates of the wheel revolution rate sensors of the other wheel revolution rate sensor group, which it does not read directly. In this case, in particular, an estimation of the wheel revolution rate sensors by a wheel revolution rate sensor of the same axle may be provided, for example an estimation of the right front wheel revolution rate sensor by equating the left front wheel revolution rates and right front wheel revolution rates. For this purpose, in particular, an embodiment with a crosswise configuration of the wheel revolution rate sensors may be provided so that the left front wheel revolution rate sensor and the rear right wheel revolution rate sensor are assigned to a first wheel revolution rate sensor group and the other two wheel revolution rate sensors are assigned to the other wheel revolution rate sensor group. This embodiment thus allows a direct estimation of the remaining wheel revolution rates.

According to an alternative embodiment, the two front wheel revolution rate sensors can be included together with one of the two rear wheel revolution rate sensors in one of the wheel revolution rate sensor groups, so that the other rear wheel revolution rate sensor remains in the other wheel revolution rate sensor group. This is based on the consideration that the rear wheel revolution rates can in principle be estimated from the revolution rates of a transmission output shaft, since in a utility vehicle in general the wheels of the rear axle are driven and thus a transmission output shaft, which is sensed by a transmission controller, delivers corresponding revolution rates of the transmission output shaft, from which the wheel revolution rates can be estimated accordingly.

Thus, in particular, the wheel revolution rate sensor group of the central brake control device can receive the two front wheel revolution rates and one of the two rear wheel revolution rates, so that problems for example in the direct data connection between the brake control devices lead to a relatively low functional impairment, since the central brake control device has already read three of the four wheel revolution rates directly.

Furthermore, the wheel revolution rate sensors can also be grouped axle-wise, wherein then the wheel revolution rates of the rear axle can again be estimated from the wheel revolution rates of a transmission output shaft if necessary.

Furthermore, an embodiment with side-by-side assignment of the wheel revolution rate sensors is possible, so that the left wheel revolution rate sensors of the front axle and rear axle are arranged in a wheel revolution rate sensor group and the two right wheel revolution rate sensors are arranged in the other wheel revolution rate sensor group.

Furthermore, in each of these embodiments, the second brake control device may be designed as an electric parking brake control device, or the electric parking brake control device already provided for an electric parking brake is used in addition as a second brake control device to ensure the redundant service braking mode or brake control mode. Here, the parking brake control device then reads the wheel revolution rate sensors of one of the two wheel revolution rate sensor groups. Such a design has some advantages; thus, the parking brake control device can actuate in particular so-called tristop cylinders with combined service brake cylinders and parking brake cylinders, wherein then a fail operation braking mode is generally guaranteed by inverse pneumatic actuation of the parking brake cylinders, i.e. by applying air to the parking brake cylinders for releasing the parking brake, and venting the parking brake cylinders for applying the parking brake to enable the auxiliary or redundant service brake system.

Here, accordingly, an—alternative or rudimentary—brake slip control is possible, by outputting corresponding pneumatic control signals to the parking brake cylinders of the respective brakes of the rear axle. Thus, in the auxiliary braking mode for example there is no pneumatic actuation of a wheel brake module of the rear axle by the second brake control device.

The two brake control devices are preferably equipped with separate power supplies, i.e. two non-mutually dependent voltage supplies, so that even in the event of failure of one of the power supplies, the other brake control device is still electrically supplied. For this purpose, two separate batteries can be provided in the vehicle, for example.

The brake slip control can be carried out in normal braking mode in particular by means of ABS shut-off valves. In particular, an ABS shut-off valve may be provided on the front axle before each wheel brake, which is electrically actuated directly by the central brake control device. When designed as an EBS, for example, a front axle brake modulator may have two proportional relay valves, which enable direct modulation of the analog brake pressure for the respective side from a connected compressed air supply, depending on the received service brake signals of the central brake control device. The brake slip control is thus carried out by the downstream ABS shut-off valves. In the event of failure of the central brake control device, the auxiliary brake slip control can thus be carried out by the pneumatic auxiliary controller of the second brake control device, which is carried out for example via an upstream bypass valve, which is actuated as an electromagnetic valve by the second brake control device and for example can modulate an analog brake control pressure directly from a connected supply pressure. Thus, the brake control mode and accordingly also the alternative brake slip control are carried out via such a bypass valve.

On the rear axle, brake slip control can preferably be carried out by means of a rear axle brake module, which accordingly controls the ABS phases of pressure increasing, pressure holding and pressure reducing directly in the connected pneumatic brake lines to the wheel brakes. Here, the alternative brake control can be carried out by means of a rear bypass valve, which is electrically actuated by the second brake control device and for example in turn modulates an analog brake pressure value direct from the connected supply pressure. The analog brake pressure value can be output to the rear axle brake module, which passes this analog brake pressure value to the rear wheel brakes in the event of a fault. Thus, here too, an alternative or rudimentary brake slip control can be carried out directly by modulating the corresponding analog brake pressure value.

With the advantageous design of the second brake control device as a parking brake control device, such a rear bypass valve can be omitted, since the parking brake control device directly actuates the pneumatic parking brake cylinders and thus can perform an inverse braking mode, which thus enables the service brake function and the brake slip control function.

Accordingly, both brake slip controls for the ABS case and wheel revolution rate controls for vehicle dynamics control can be performed in order to enable instabilities due to asymmetric actuation of the wheel brakes.

The direct data connection between the two control devices may in particular be a bus line, which is provided in particular to be connected directly to only these two control devices separately from other control devices.

The wheel revolution rate sensors can be active or passive without any functional limitations here.

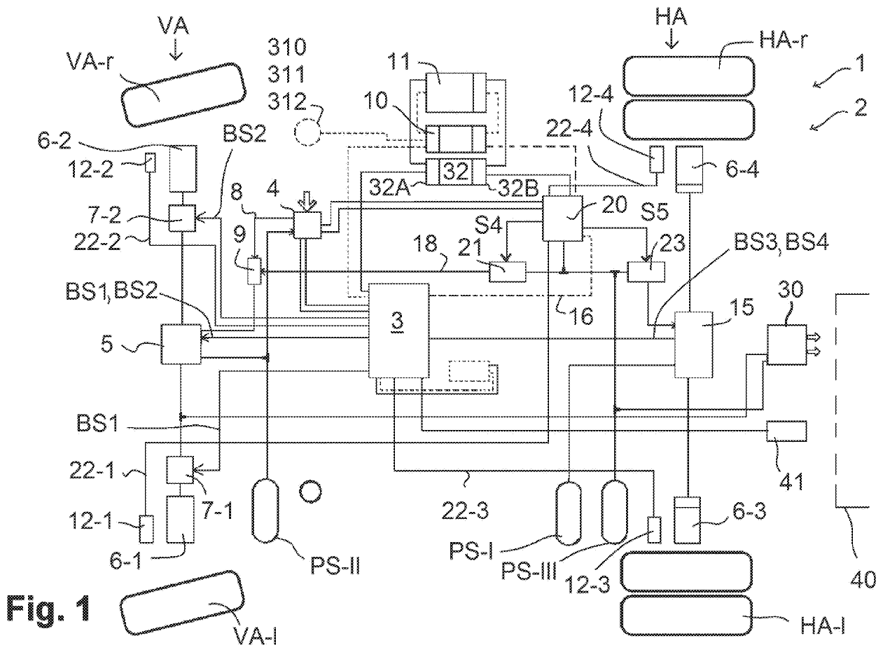

According to FIG. 1, a utility vehicle 1 has an electropneumatic brake system 2. Furthermore, the utility vehicle 1 has a front axle VA with a left front wheel VA-1 and a right front wheel VA-r, and correspondingly a rear axle HA with a left rear wheel HA-1 and a right rear wheel HA-r, wherein here for example dual tires can be used on the rear axle HA in a conventional manner.

The electropneumatic brake system 2 has a central electronic brake control device 3 (ECU-EBS), a brake pedal 4 for operation by the driver, a front axle brake module 5 for actuating a left front brake cylinder 6-1 via a first ABS shut-off valve 7-1 (ABS solenoid valve) and correspondingly for actuating a front right brake cylinder 6-2 via a front right ABS shut-off valve 7-2; furthermore, the electropneumatic brake system 2 correspondingly has a rear axle brake module 15 for controlling a rear left brake cylinder 6-3 and a rear right brake cylinder 6-4.

The more detailed design of the brake modules 5, 15 and brake cylinders 6-i, i.e. 6-1, 6-2, 6-3 and 6-4, can be carried out differently. According to the embodiment shown, the electropneumatic brake system 2 can be designed here as an EBS brake system or electronic brake system, which thus allows a direct brake pressure modulation on the axles VA, HA. According to the embodiment shown, the front axle brake module 5 may in particular have a proportional control valve and may receive compressed air from a second compressed air circuit or a second compressed air supply PS2 and may modulate at the two front brake cylinders 6-1,6-2 via the ABS solenoid valves 7-1, 7-2. In this case, according to the embodiment shown, for example a pneumatic fallback level is provided by a pneumatic connection 8 between the brake pedal 4 and the front axle brake module 5, which here additionally has a select-high valve 9, which will be discussed later.

The central electronic brake control device 3 receives a driver brake signal S1, and also if appropriate brake demand signals S2 from other controllers or control devices of the utility vehicle 1, for example an Autonomous Driving ECU 11, via a vehicle-internal first data bus, in particular a CAN bus 10.

Furthermore, for example, vehicle dynamics control or stability control may be provided in the electronic central brake control device 3 itself or may be transmitted or requested as an external brake demand signal S2 to the central brake control device 3.

On the rear axle HA, the rear axle brake module 15 can also additionally control the ABS control, for example as shown. Furthermore, the rear brake cylinders 6-3, 6-4 can also additionally implement the parking brake function, i.e. for example may have an additional pressure chamber for releasing a spring-preloaded wheel brake.

Other designs of the ABS shut-off valves and brake modules on the rear axle HA and front axle VA are also possible.

Furthermore, in the design shown here no pneumatic fallback level is directly provided for the rear axle HA; however this may also be provided correspondingly.

A wheel revolution rate sensor 12-i, i=1 to 4 is provided on each of the vehicle wheels VA-1, VA-r, HA-1, HA-r, i.e. a front left wheel revolution rate sensor 12-1 on the left front wheel VA-1, correspondingly a front right wheel revolution rate sensor 12-2 on the right front wheel VA-r, and correspondingly rear wheel revolution rate sensors 12-3, 12-4 on the rear wheels HA-1, HA-r. The wheel revolution rate sensors 12-i can be passive, i.e. delivering signals in the event of movement of the vehicle wheels, or also active, i.e. in particular also performing active measurement and for example delivering digital signals.

Here, the wheel revolution rate sensors 12-i are divided into two groups 14A and 14B, wherein this division is carried out differently in the different embodiments as explained below. The first group 14A is formed in the embodiment according to FIG. 1 by the front left wheel revolution rate sensor 12-1 and the rear right wheel revolution rate sensor 12-4 and sends the wheel revolution rate signals S12-1, S12-3 to a second brake control device (FOBS-ECU) 20. The second wheel revolution rate group 14B is formed accordingly by the front right wheel revolution rate sensor 12-2 and the rear left wheel revolution rate sensor 12-3, wherein these send their wheel revolution rate signals S12-2 and S12-3 to the central brake control device (first brake control device) 3. Here, for safety reasons, generally direct signal lines 22-1, 22-2, 22-3, 22-4 are laid between the wheel revolution rate sensors 12-i and the control devices 3, 20.

In the embodiment of FIG. 1, a crosswise configuration of the groups 14A, 14B of the wheel revolution rate sensors 12-i is thus carried out.

The two brake control devices 3, 20 are connected via a direct data connection 16, for example a direct data bus or a serial data line. Advantageously, this direct data line 16 is different from the central vehicle bus or CAN bus 10.

Thus, the central brake control device 3 first detects the wheel revolution rate signals S12-2, S12-3; furthermore, the second brake control device 20 detects the wheel revolution rate signals S12-1, S12-4 and subsequently sends them via the direct data line 16 to the central brake control device 3.

According to FIG. 1, a pneumatic brake auxiliary line 18 (pneumatic brake auxiliary control line 18) which emanates from the second brake control device 20, can be used by the second brake control device 20 to carry out auxiliary brake control on both axles VA and HA in the event of a failure of the central brake control device 3. Thus, the first brake auxiliary control line or front axle brake auxiliary control line 18 goes to the front axle brake modulator 5, in particular via the select high valve 9, which can thus pass through the higher of the actuated brake pressures on the one hand from the brake pedal 4 via the pneumatic brake auxiliary control line 8 and the front axle brake auxiliary control line 18 on the other hand. For this purpose, advantageously a front bypass valve 21 is switched between the second brake control line 20 and the select high valve 9, which accordingly can be actuated by means of an electrical auxiliary brake control signal S4 from the second brake control device 20. Accordingly, in this embodiment a rear bypass valve 23 is provided for the rear axle auxiliary control for correspondingly actuating the rear axle brake modulator 15, which is actuated by means of an electrical auxiliary brake control signal S5, wherein here the bypass valves 21, 23 for pneumatic auxiliary control are connected to a third storage tank PS-III as a pneumatic fallback level.

In a conventional manner, a trailer control module 30 is connected to the third supply circuit III. An electrical connection of the trailer 40 indicated here can be made via a trailer control line 41, i.e. a corresponding data connection according to ISO 11992 from the central brake control device 3.

Thus, in the brake system 2 of the embodiment of FIG. 1, a central brake control is provided by means of brake control signals BS1, BS2, BS3, BS4, which are output from the brake control device 3 to the axle brake modules 5.15 and/or the ABS shut-off valves 7-2, 7-1. An electrical actuation by the second brake control device 20 is thus not provided in the normal case; the second brake control device 20 only routinely reads the two wheel revolution rate sensors 12-1 and 12-4 and outputs the determined wheel revolution rates as wheel rotation signals S12-1, S12-4 to the central brake control device 3.

Thus, in the normal mode, the second brake control device 20 is only used for reading one of the two wheel revolution rate sensor groups, here the first group 14A, and for communication with the (first) central brake control device 3; in the event of a complete or partial failure of the first brake control device 3, a replacement control mode or an auxiliary control mode or a redundant control mode of this electropneumatic brake system 2 or the brake cylinders 6-1, 6-2, 6-3, 6-4 is carried out by the second brake control device 20.

The power supply of the two brake control devices 3 and 20 is carried out separately: A power supply device 32 has two separate power supplies 32A and 32B, which for example each provide a supply voltage U1 or U2 of 24 V, wherein alternatively supply voltages U1, U2 of 12 V can be provided. Here, advantageously, separate batteries are provided in the utility vehicle 1. Thus if the first power supply 32A fails, for example, the second power supply 32B is still present, which supplies the second brake control device 20 with voltage or current, thus maintaining the redundant auxiliary brake control mode.

The electropneumatic brake system 2 not only enables a redundant brake control mode, but also redundant brake slip control. If for example the wheel revolution rate signals S12-1, S12-3 fail, since for example the second brake control device 20 is defective or not operational due to a lack of power supply, the first, central brake control device 3 can estimate the missing wheel revolution rates; in particular it can first be assumed with this crosswise arrangement that the wheel revolution rates on each axle VA, HA are the same on the left and right to realize an auxiliary or rudimentary failure case brake slip control (fail operation brake system, FOBS). This is particularly possible for ABS slip control

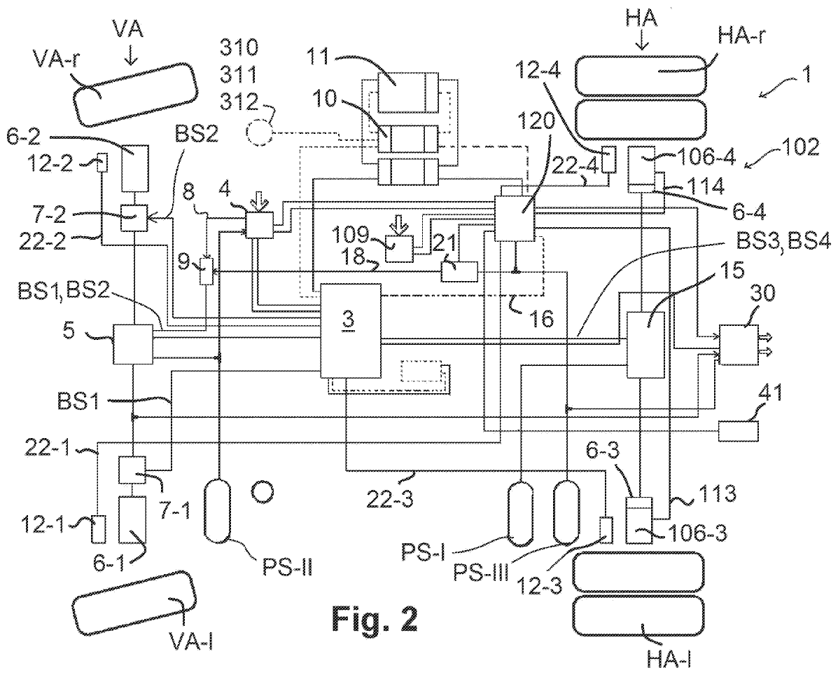

FIG. 2 shows an electropneumatic brake system 102 as a second embodiment in which an electronic parking brake control device 120 serves as a second electric brake control device, i.e. corresponding to the second electric brake control device 20 of the first embodiment of FIG. 1. The structure and functionality of the central brake control device 3 and the brake cylinders 6-i, i=1, 2, 3, 4, the wheel revolution rate sensors 12-i and the ABS shut-off valves 7-1, 7-2, the select-high valve 9, the brake pedal 4 and also the other lines, including the compressed air supplies and also the trailer control valve 30 and the rear axle brake modulator 15 remains unchanged. The parking brake control device 120 is thus also connected via the direct data line 16 to the central brake control device 3.

According to FIG. 2 a parking brake actuating means 109 is further provided for operation by the driver, i.e. as a parking brake pedal, for example, which accordingly is read electrically by the electric parking brake control device 120.

Furthermore, the rear bypass valve 23 between the parking brake control device 120 and the rear axle brake modulator 15 is omitted, since the parking brake control device 120 actuates the rear brake cylinders 6-3, 6-4 in the form of tristop cylinders 116 via pneumatic parking brake control lines 113, 114. Thus, in the event of failure of the central brake control device 3 the redundant brake control mode or the service braking mode can be maintained by means of pneumatic actuation signals of the parking brake control device 120 via the pneumatic parking brake control lines 113, 114; this pneumatic auxiliary mode thus provides for an inversion of the pneumatic signals to the spring chambers or parking brake cylinders 106-3, 106-4 of the rear brake cylinders 6-3, 6-4 in the form of tristop cylinders 116, so that the parking brake chambers are vented to apply the service brakes or the service brake function, and the parking brake chambers are pressurized to release the service brake function.

Thus, the second embodiment with the pneumatic brake system 102 according to FIG. 2—corresponding to the embodiment of FIG. 1—in particular enables the crosswise configuration of the wheel revolution rate sensors 12-i and an auxiliary brake control mode and also an auxiliary brake slip control mode (FOBS), and further the synergistic advantage of the use of the parking brake control device as a second brake control device, so that no additional second brake control device is necessary here; furthermore, no additional bypass valve is necessary on the rear axle HA for the redundant service braking mode.

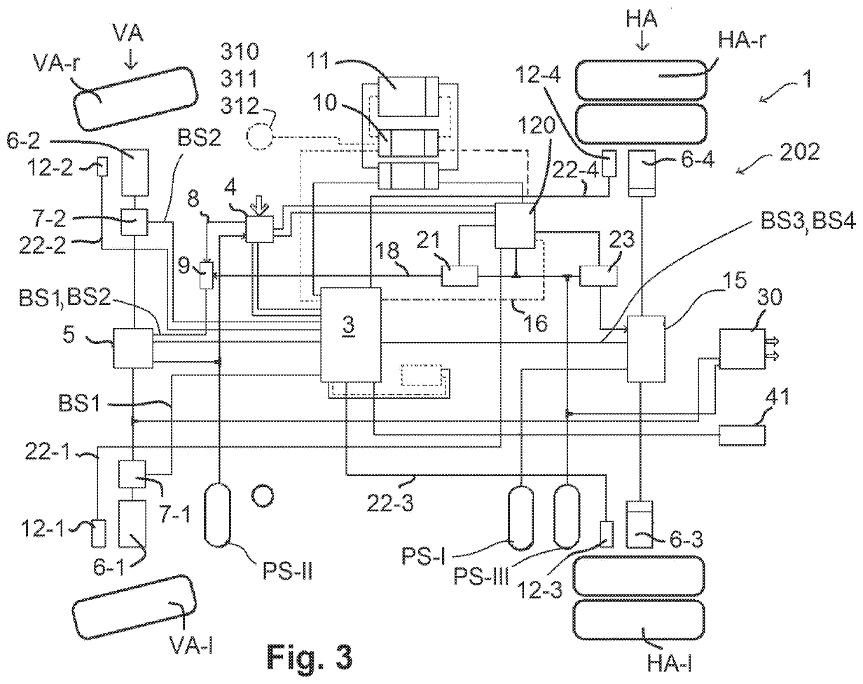

The embodiment of FIG. 3 shows an electropneumatic brake system 202, in which the wheel revolution rate sensors 12-i are not subdivided crosswise, but asymmetrically. Here, the two rear axle wheel revolution rate sensors 12-3, 12-4 and one of the two front wheel revolution rate sensors, here the right front wheel revolution rate sensor 12-2, form the first wheel revolution rate sensor group 214A, and correspondingly the further front wheel revolution rate sensor, here thus the left front wheel revolution rate sensor 12-1, forms the second wheel revolution rate sensor group 214B.

Here too, in the event of failure of the central brake control device 3 or its first power supply V1, the second brake control device 20—corresponding to the first embodiment of FIG. 1—can take over the auxiliary service braking mode, again by pneumatic actuation of the front axle VA via the select-high valve 9 to the front axle brake modulator 5, and accordingly via the rear bypass valve 23 pneumatically to the rear axle brake modulator 15. If this embodiment is combined with the embodiment of FIG. 2, the second brake control device 20 can accordingly directly pneumatically actuate the parking brake cylinders 106-3, 106-4 of the rear brake cylinders 6-3, 6-4 in the form of tristop cylinders 116 without a rear bypass valve 23.

Furthermore, a fail operation slip control mode is also possible with this embodiment of FIG. 3, wherein in particular the wheel revolution rates of the rear vehicle wheels HA-1 and HA-r, which are generally driven in the utility vehicle, can be estimated from transmission output shaft revolution rate signals S40, which the second brake control device 20 can receive from a transmission control device, for example, via the vehicle-internal data bus or CAN bus 10, for example. Thus, the revolution rates of the rear wheels HA-1 and HA-r can be estimated. Since the second brake control device 20 receives the wheel revolution rate signals S20-1 of the left front wheel VA-1 (or alternatively, the right front wheel VA-r) directly, it can in turn estimate the revolution rate of the other side in the fail operation slip control mode by setting the revolution rate on the front axle VA as the same.

As already explained, the embodiments of FIGS. 2 and 3 can be suitably combined, so that accordingly the parking brake control device 120 of FIG. 2 is used in FIG. 3 instead of the second brake control device 20.

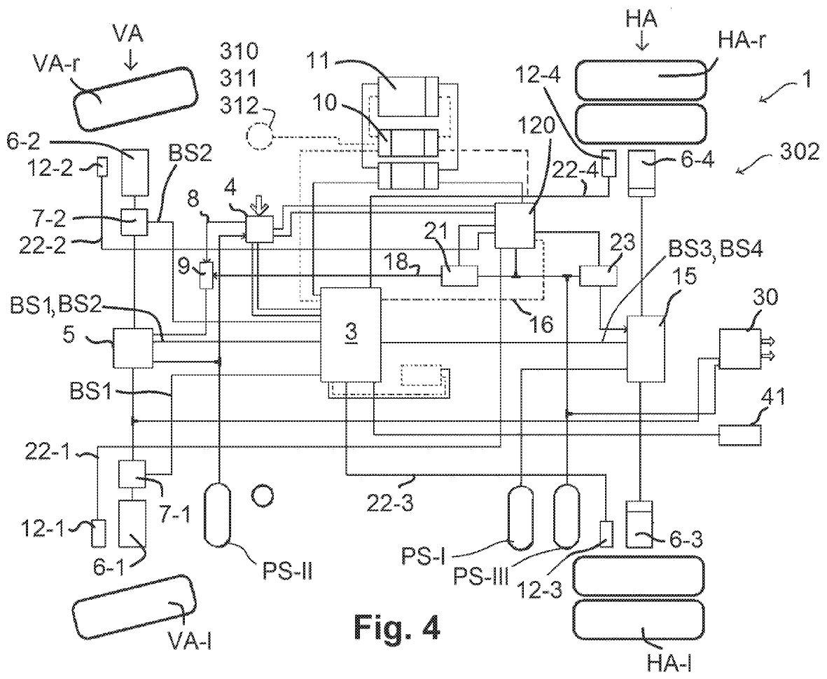

The fourth embodiment of FIG. 4 shows an electropneumatic brake system 302, in which an axle-wise assignment of the wheel revolution rate sensor groups 314A, 314B is carried out: The first wheel revolution rate sensor group 314A has the front wheel revolution rate sensors, i.e. the left front wheel revolution rate sensor 12-1 and the right front wheel revolution rate sensor 12-2, which are thus read by the second brake control device 20. The second wheel revolution rate sensor group 314B has the two rear wheel revolution rate sensors, i.e. the rear left wheel revolution rate sensor 12-3 and the rear right wheel revolution rate sensor 12-4, which are thus read by the central brake control device 3.

In a fail operation slip control mode, in principle, the absent wheel revolution rates of the rear axle HA can be estimated from the transmission output shaft revolution rate signals S40, corresponding to the embodiment of FIG. 3, so that the second brake control device 20 can perform a pneumatically actuated service braking mode and the supplementary slip control mode, wherein here both wheel revolution rate signals S12-1, S12-2 of the front axle VA are available.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

1 utility vehicle
2, 102, 202, 302 electropneumatic brake system
3 central electronic brake control device
4 brake pedal, in particular with pneumatic and electrical output
5 front axle brake module
6-i brake cylinder
6-1 front left brake cylinder
6-2 front right brake cylinder
6-3 rear left brake cylinder, in particular as a tristop brake cylinder with combined parking brake function through two brake chambers, a pneumatic service brake chamber and a pneumatic parking brake chamber, which acts against a spring preload of the parking brake
6-4 rear right brake cylinder, in particular as a tristop brake cylinder, with combined parking brake function through two brake chambers, a pneumatic service brake chamber and a pneumatic parking brake chamber, which acts against a spring preload of the parking brake
7-1, 7-2 ABS shut-off valves, especially on the front axle VA
8 pneumatic auxiliary brake control line for pneumatic braking operation on the front axle VA
9 select high valve
10 vehicle-internal data bus, in particular a CAN bus
11 external control unit for autonomous driving, autonomous driving ECU
12-i wheel revolution rate sensors
12-1 front left wheel revolution rate sensor
12-2 front right wheel revolution rate sensor
12-3 rear left wheel revolution rate sensor
12-4 rear right wheel revolution rate sensor
14A, 214A, 314A first wheel revolution rate sensor group
14B, 214B, 314B second wheel revolution rate sensor group
15 Rear axle brake module, for example with two relay valves
16 direct data connection, for example bus connection between the brake control devices 3, 20
18 pneumatic brake auxiliary control line for the pneumatic auxiliary brake control mode by the second brake control device 20, 120 on the front axle VA
20 second brake control device, auxiliary brake control device, for auxiliary brake control mode
21 front bypass valve 21 between the second brake control line 20 and the select high valve 9
22-1, 22-2, 22-3, 22-4 direct signal lines between the wheel revolution rate sensors 12-i and the control devices 3, 20
23 rear bypass valve for the rear axle auxiliary control for pneumatic actuation of the rear axle brake modulator 15
30 trailer control module, TCM
32 power supply device
32A first power supply
32B second power supply
40 trailer
41 trailer control line, in particular data connection according to ISO 11992
100 service braking mode
100a auxiliary service braking mode
105 redundant auxiliary braking mode
105-1 pneumatic redundancy actuation of the front axle
105-2 pneumatic redundancy actuation of the rear axle
106-3, 106-4 parking brake cylinders, spring chambers of the tristop cylinders
100a auxiliary service braking mode of the parking brake control device 120
116 tristop cylinders
109 parking brake actuating means, for example parking brake pedal
113, 114 pneumatic parking brake control line
120 parking brake control device
310 electronic stability system (vehicle-internal system, connected via vehicle-internal data bus 10)
311 distance control system (vehicle-internal system, connected via vehicle-internal data bus 10)
312 emergency brake system (vehicle-internal system, connected via vehicle-internal data bus 10)
HA rear axle
HA-1 left rear wheel
HA-r right rear wheel
n1, n2, n3, n4 wheel revolution rates
S1 driver brake signal
S2 external braking demand signal
S4 electric auxiliary brake control signal from the second brake control device 20 to the front bypass valve 21 between the second brake control line 20 and the select high valve 9
S5 electric auxiliary brake control signal from the second brake control device 20 to the rear bypass valve 23
BS1, BS2, BS3, BS4 brake control signals
S12-i wheel revolution rate signals of the wheel revolution rate sensor 12-i
S40 transmission output shaft revolution rate signal
VA front axle
VA-1 left front wheel
VA-r right front wheel
U1, U2 first power supply, second power supply, for example two batteries
PS-I, PS-II, PS, III first, second third pneumatic supply circuits, storage tank
ABS brake slip control, in particular ABS brake slip control
H_ABS alternative brake slip control
SR stability control and/or vehicle dynamics control
SR2 selective, for example right and left asymmetrical, brake control
p_6_1 analog pressure control value at brake cylinder 6-1
p_6_2 analog pressure control value at brake cylinder 6-2

1. An electropneumatic brake system for a utility vehicle, the electropneumatic brake system comprising:
a front first brake cylinder and a front second brake cylinder on a front axle, the front first brake cylinder and the front second brake cylinder are configured to brake respective first and second front vehicle wheels;
a rear first brake cylinder and a rear second brake cylinder on a rear axle, the rear first brake cylinder and the rear second brake cylinder are configured to brake respective first and second rear vehicle wheels;
a central brake control device configured to output of brake control signals for pneumatic pressurization of the front first and second brake cylinders and the rear first and second brake cylinders;
two front wheel revolution rate sensors and two rear wheel revolution rate sensors configured to sense respective wheel revolution rates of the first and second front vehicle wheels and the first and second rear vehicle wheels and further configured to output respective wheel revolution rate signals; and
a second brake control device configured to actuate, in an at least partially electric auxiliary braking mode, the front first and second brake cylinders and the rear first and second brake cylinders in event of failure of the central brake control device
wherein the two front wheel revolution rate sensors and the two rear wheel revolution rate sensors are divided into a first wheel revolution rate sensor group and a second wheel revolution rate sensor group,
wherein the first wheel revolution rate sensor group outputs is configured to output respective wheel revolution rate sensor signals to the second brake control device, which is configured to relay the respective wheel revolution rate sensor signals to the central brake control device,
wherein the second wheel revolution rate sensor group outputs is configured to output its wheel revolution rate sensor signals to the central brake control device,
wherein the central brake control device is designed to electrically actuate a slip controller of the vehicle wheels, and
wherein the second brake control device is designed to actuate an auxiliary brake slip controller of the brake cylinders with the respective wheel revolution rate sensor signals of the first wheel revolution rate sensor group in the event of the failure of the central brake control device.

2. The brake system as claimed in claim 1, wherein the central brake control device has a first power supply and the second brake control device has a second power supply separate from the first power supply.

3. The brake system as claimed in claim 1, wherein a direct data connection is provided between the central brake control device and the second brake control device.

4. The brake system as claimed in claim 1, wherein the front first and second brake cylinders are pneumatically actuated via front ABS shut-off valves, wherein the central brake control device is configured to output electrical brake control signals to the front ABS shut-off valves.

5. The brake system as claimed in claim 1, wherein a front axle brake modulator is provided for pneumatic actuation of the two front first and second brake cylinders, wherein the front axle brake modulator is configured to receive the brake control signals from the central brake control device.

6. The brake system as claimed in claim 1, wherein a rear axle brake module is provided for pneumatic actuation of the rear first and second brake cylinders.

7. The brake system as claimed in claim 1, wherein the second brake control device has a front electromagnetic bypass valve for pneumatic redundancy actuation of front first and second wheel brakes and/or a rear electromagnetic bypass valve for pneumatic redundancy actuation of the rear first and second wheel brakes for the at least partially electric auxiliary braking mode.

8. The brake system as claimed in claim 1, wherein the wheel revolution rate sensors are divided crosswise into the wheel revolution rate sensor groups.

9. The brake system as claimed in claim 1, wherein one of the two wheel revolution rate sensor groups has only one front wheel revolution rate sensor and the two rear wheel revolution rate sensors and the other front wheel revolution rate sensor are included in the other wheel revolution rate sensor group,
wherein the brake control devices are designed to receive transmission output shaft revolution rate signals via a vehicle-internal data system for estimating the wheel revolution rates of the rear wheels.

10. The brake system as claimed in claim 1, wherein the two front wheel revolution rate sensors are included in a wheel revolution rate sensor group and the two rear wheel revolution rate sensors are included in the other wheel revolution rate sensor group.

11. The brake system as claimed in claim 1, wherein the second brake control device is designed as a control device of an electric parking brake, for direct pneumatic actuation of pneumatic parking brake cylinders of the rear wheel brakes, which are designed as combined service brake cylinders and parking brake cylinders, wherein the parking brake control device is designed to perform service braking processes and brake slip controls on the rear wheel brakes during the auxiliary at least partially electric service braking mode by pneumatic actuation of the pneumatic parking brake cylinders.

12. The brake system as claimed claim 1, wherein the second brake control device is designed to continue to perform stability control during the at least partially electric auxiliary service braking mode by selective brake actuation of the left and right wheel brakes.

13. The brake system as claimed in claim 1, wherein a service brake actuating device outputs electrical driver brake signals to the central brake control device, and
wherein the brake system is designed as an electronic brake system and the central brake control device is configured to output electrical brake control signals to a front axle brake module and a rear axle brake module.

14. The brake system as claimed in claim 1, wherein the second brake control device is designed as a trailer brake control device for actuating a trailer control module for the pneumatic supply of a trailer to be connected.

15. The brake system as claimed in claim 1, wherein the central brake control device is configured to receive external brake demand signals via a vehicle-internal data system and to output brake control signals depending on the external brake demand signals.

16. The brake system as claimed in claim 1, wherein, in the event of electrical failure of the second brake control device, the central brake control device is configured to estimate the wheel revolution rates of the first wheel revolution rate sensor group, which are received via a vehicle data system.

17. A method for controlling an electropneumatic brake system as claimed in claim 1, the method comprising:
in the event of a failure of the central brake control device, estimating, by the second brake control device, the wheel revolution rates of the second wheel revolution rate sensor group and performing a service braking mode by actuating the front and rear wheel brakes and a brake slip mode by brake slip control of the wheel brakes.

18. The method as claimed in claim 17, wherein
in the event of failure of the second brake control device, estimating, by the central brake control device, the wheel revolution rates of the wheel revolution rate sensors of the first wheel revolution rate sensor group and performing brake slip control of the wheel brakes of the first wheel revolution rate sensor group.

19. A vehicle, with an electropneumatic brake system as claimed in claim 1.
